(19) United States
(12) Patent Application Publication
(10) Pub. No.: US 2020/0409997 A1
(43) Pub. Date: Dec. 31, 2020

(54) METHOD AND SYSTEM FOR DETERMINING SAME CONTENTS ON THE BASIS OF COMMENTS BY TIME

(71) Applicant: MLAB INC., Seoul (KR)

(72) Inventor: Eui Jae HONG, Seoul (KR)

(21) Appl. No.: 16/307,769

(22) PCT Filed: Jun. 29, 2018
(86) PCT No.: PCT/KR2018/007377

§ 371 Date: Dec. 6, 2018

(51) Int. Cl. G06F 16/78; G06F 16/735

(52) U.S. Cl. CPC G06F 16/7867; G06F 16/735

(57) ABSTRACT

A method of determining equality between contents according to an embodiment of the present invention includes: reading, by a comment information management unit, comment information on a first video content from a database; reading, by the comment information management unit, comment information on a second video content from the database; and determining, by a comment information comparison unit, equality between the first video content and the second video content by comparing the comment information on the first video content and the comment information on the second video content.

### TECHNICAL FIELD

The present invention relates to a method and a system for determining equality (sameness) between video contents on the basis of comments by time.

### BACKGROUND ART

Video content services are increased recently as digital contents techniques are developed. In accordance with these trends, information on a video content can be shared as users leave comments (tags) on the corresponding video content, and the comments may be mapped to a specific time point or a specific time section of the video. Meanwhile, as numerous video contents are created, there are a large number of contents, all or parts of which are equal, and accordingly, techniques capable of determining equality or similarity between video contents are required.

### DISCLOSURE OF INVENTION

### Technical Problem

The present invention provides a method and a system for determining whether video contents are equal or similar to each other on the basis of comments mapped to the video contents by time.

### Technical Solution

A method of determining equality between contents according to an embodiment of the present invention includes: reading, by a comment information management unit, comment information on a first video content from a database; reading, by the comment information management unit, comment information on a second video content from the database; and determining, by a comment information comparison unit, equality between the first video content and the second video content by comparing the comment information on the first video content and the comment information on the second video content.

In an embodiment, the method of determining equality between contents further includes reflecting, by the comment information management unit, the comment information on the first video content in the comment information on the second video content and recording the comment information on the second video content in the database, when it is determined that the first video content and the second video content are equal to each other.

In an embodiment, the method of determining equality between contents further includes: reading, by the comment information management unit, comment information on a third video content from the database, and determining, by the comment information comparison unit, equality between the second video content and the third video content by comparing the comment information on the second video content and the comment information on the third video content, before reflecting the comment information on the first video content in the comment information on the second video content; and determining again, by the comment information comparison unit, when it is determined that the second video content and the third video content are inequal, equality between the second video content and the third video content by comparing again the comment information on the second video content and the comment information on the third video content, after reflecting the comment information on the first video content in the comment information on the second video content.

In an embodiment, the comment information management unit reflects only information on comments having high frequency or reliability among the comment information on the first video content in the comment information on the second video content and records the comment information on the second video content in the database.

In an embodiment, the method of determining equality between contents further includes automatically creating and recording, by a comment information creation unit, the comment information on the second video content in the database on the basis of the second video content, when the comment information on the second video content is not in the database.

In an embodiment, determining equality includes determining equality between a time section of the first video content and a time section of the second video content.

In an embodiment, determining equality includes determining equality on the basis of similarity between contents of comments and similarity between mapping times of the comments.

In an embodiment, determining equality includes determining similarity between contents of the comments considering different languages.

In an embodiment, determining equality includes determining similarity between mapping times of the comments considering movement on a time axis.

In an embodiment, determining equality includes determining similarity between mapping times of the comments considering expansion/contraction on a time axis.

In an embodiment, determining equality includes determining equality on the basis of frequencies of the comments.

In an embodiment, determining equality includes determining equality on the basis of reliability of the comments.

In an embodiment, determining equality includes determining equality on the basis of information on users who inputted the comments.

In an embodiment, determining equality includes determining equality on the basis of information on input situations of the comments.

In an embodiment, determining equality includes: visualizing and outputting the comment information on the first video content and the comment information on the second video content according to mapping times of comments; and receiving information on the equality between the first video content and the second video content from a user.

In an embodiment, visualizing and outputting the comment information includes visualizing and outputting the comment information in different methods according to at least one criterion among a type of the comment, frequencies of the comments, reliability of the comments, information on users who inputted the comments, and information on input situations of the comments.

A system for determining equality between contents according to an embodiment of the present invention includes: a comment information management unit for reading comment information on a first video content and comment information on a second video content from a database; and a comment information comparison unit for determining equality between the first video content and the second video content by comparing the comment information on the first video content and the comment information on the second video content.

The present invention includes a computer-readable recording medium for storing a program for executing a method according to an embodiment of the present invention.

### Advantageous Effects

According to the present invention, equality or similarity between video contents can be determined using information on comments by time, inputted by users or automatically created.

### BRIEF DESCRIPTION OF THE DRAWINGS

FIG. 1 is a block diagram schematically showing the configuration of a system for determining equality between contents according to an embodiment of the present invention.

FIG. 2 is a flowchart illustrating the flow of a method of determining equality between contents according to an embodiment of the present invention.

FIG. 3 is a view showing an example of mapping similar comments to two video contents.

FIG. 4 is a view showing an example in which equal comments are distributed in different time sections of two video contents at the same time intervals.

FIG. 5 is a view showing an example in which equal comments on two video contents are distributed at double time intervals.

FIG. 6 is a view showing an example in which equal comments are mapped to two video contents in languages different from each other.

### BEST MODE FOR CARRYING OUT THE INVENTION

Hereafter, preferred embodiments of the present invention will be described in detail with reference to the accompanying drawings to make the spirit of the present invention clear. In describing the present invention, when it is determined that the detailed description of the known art related to the present invention may obscure the gist of the present invention, the detailed description thereof will be omitted. Wherever possible, the same reference numerals and symbols are assigned to the components having practically the same functional configuration in the drawings although they are shown in different drawings. For the convenience of explanation, the apparatus and the method will be described together if needed.

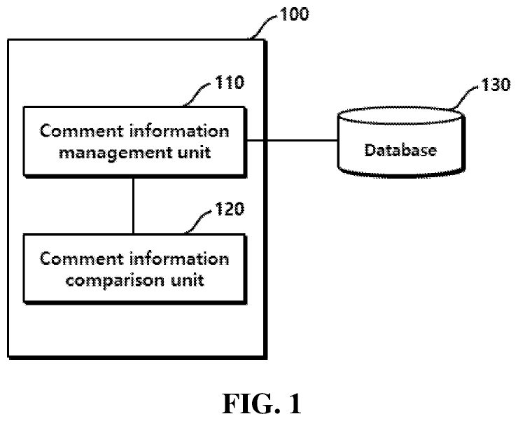

FIG. 1 is a block diagram schematically showing the configuration of a system for determining equality between contents according to an embodiment of the present invention. Referring to FIG. 1, a content equality determination system 100 according to an embodiment of the present invention includes a comment information management unit 110 and a comment information comparison unit 120. The comment information management unit 110 may read comment information on a video content recorded in a database 130 or record comment information on a video content in the database 130. Here, the comment information is information on comments mapped to the video content by time, and the comments may be inputted by users or automatically created on the basis of the video content. The database 130 may be included in the content equality determination system 100 or may be an external device. The comment information comparison unit 120 may compare comment information on a plurality of video contents and determine equality between the video contents.

Here, the equality between video contents may mean that the entire video contents are equal or parts of the video contents are equal. That the entire video contents are equal does not necessarily mean that data of the video contents are equal. For example, even in the case of video contents of the same movie, the data may vary according to a screen resolution, a frame rate, a compression method, a compression level or the like, and although the data of the video contents are different, the video contents may be regarded as equal video contents if the videos represented by the data are the same. Meanwhile, the same video may be expanded/contracted on the time axis, i.e., a playback time may be slower or faster, and in this case, the video contents may be regarded as the same video content. For example, in the case of a TV content, the playback time of the same video may slightly vary according to conversion between a method of 60 Hz vertical resolution and a method of 50 Hz vertical resolution, and the same video may be edited to a slow motion or a fast motion, and in this case, the video contents may be regarded as the same video content. In addition, even in the case of the same video, there may be a change in the video, such as cutting off some of the scenes according to a screen ratio or hiding some of the scenes according to censorship, and in this case, the video contents may also be regarded as the same video content. That is, in the present invention, equality between video contents may include similarity between the videos in a further broad sense, as well as perfect equality between the videos, and this will be expressed in general as equality for the convenience.

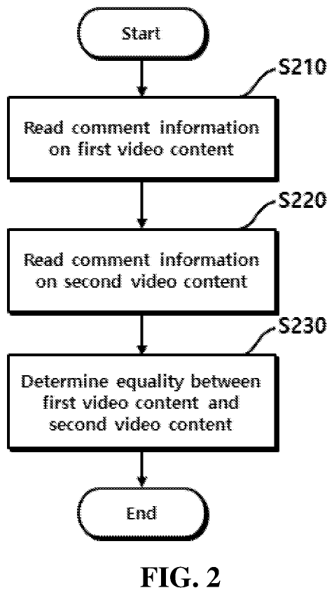

FIG. 2 is a flowchart illustrating the flow of a method of determining equality between contents according to an embodiment of the present invention. Referring to FIG. 2, a method of determining equality between contents includes reading comment information on a first video content from the database by the comment information management unit 110 (step S210), reading comment information on a second video content from the database by the comment information management unit 110 (step S220), and determining, by the comment information comparison unit 120, equality between the first video content and the second video content by comparing the comment information on the first video content and the comment information on the second video content (step S230).

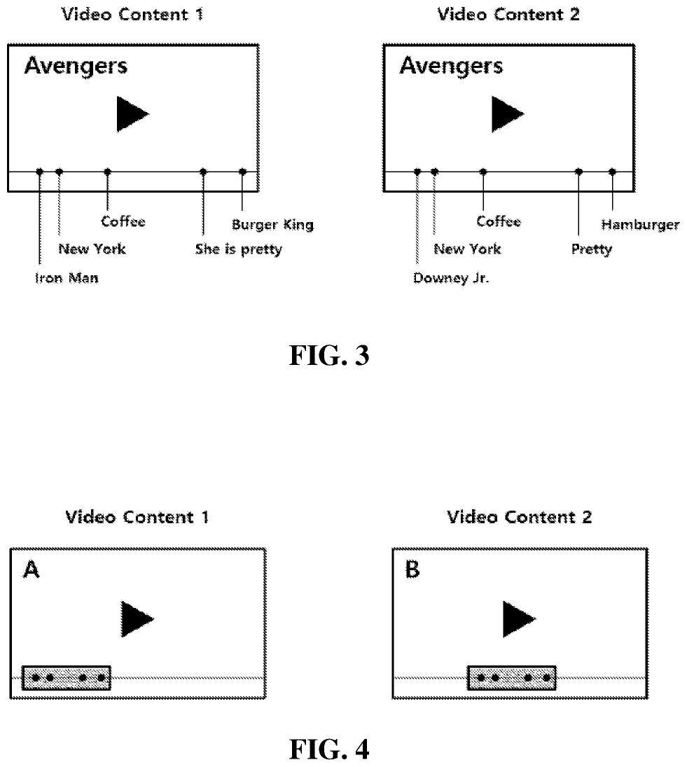

If the two video contents are equal to each other, comments thereon may also be equal or similar to each other. Therefore, the content equality determination system 100 according to the present invention determines whether the two video contents are equal to each other by comparing the comment information on the two videos. For example, if a comment “Iron man” and a comment “Burger King” are respectively mapped at playback times of 1:10 and 5:30 of a first video content, and a comment “Robert Downey, Jr.” and a comment “Hamburger” are respectively mapped at playback times of 1:11 and 5:20 of a second video content, the two videos may be determined as the same video since the contents and the mapping times of the comments are similar to each other. Like this, the comment information comparison unit 120 may determine equality between two videos on the basis of similarity between the mapping times of comments and similarity between the contents of the comments. Here, it is apparent that similarity includes equality. FIG. 3 is a view showing an example of mapping similar comments to two video contents.

The comment information comparison unit 120 may determine equality between a time section of the first video content and a time section of the second video content. Here, the time section of the first video content and the time section of the second video content may be time sections different from each other. That is, contents of the two videos may not be entirely equal, but partially equal, and the content equality determination system 100 according to the present invention may also detect cases of partially equal videos like this. For example, as some scenes of a movie is deleted by censorship, some scenes are added in an edited version of a director's cut, or advertisements are inserted in front of or in the middle of a video, parts of the video contents may be equal to each other although all the video contents are not equal. In addition, only parts of a video content may be included in another video content to show some scenes of a movie in a movie introduction program.

To determine partial equality between video contents like this, the comment information comparison unit 120 may consider movement on the time axis in determining similarity between mapping times of comments. For example, if the content and temporal distribution of comments mapped between one to eleven minutes of the playback time of the first video content are similar to the content and temporal distribution of comments mapped between five to fifteen minutes of the playback time of the second video content, the corresponding parts of the two videos may be determined as video contents equal to each other. FIG. 4 is a view showing an example in which equal comments are distributed in different time sections of two video contents at the same time intervals.

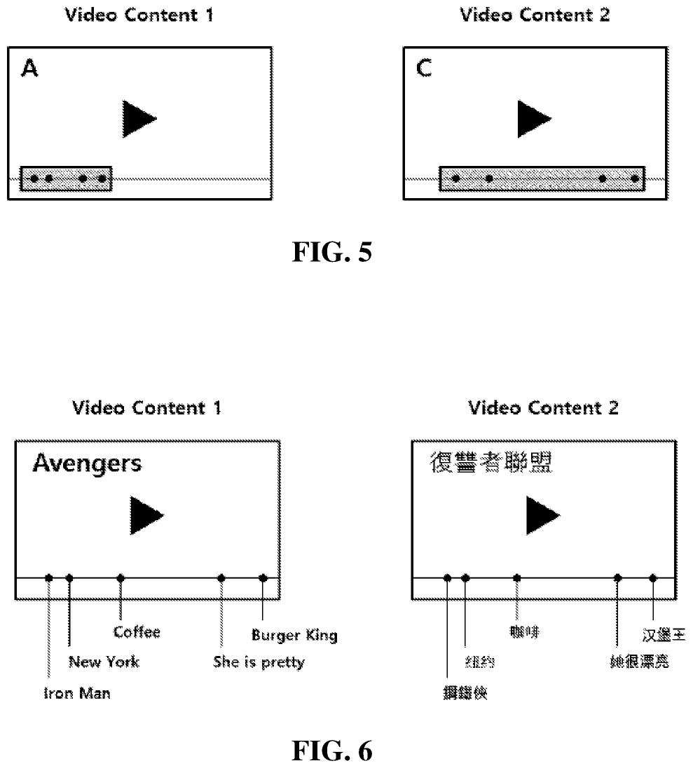

To determine equality when a video is expanded/contracted on the time axis as described above, the comment information comparison unit 120 may consider expansion/contraction on the time axis in determining similarity between mapping times of comments. For example, if comments mapped between five to fifteen minutes of the playback time of the first video content are similar to comments mapped between ten to thirty minutes of the playback time of the second video content considering double expansion of mapping time, corresponding parts of the two videos may be determined as video contents equal to each other. FIG. 5 is a view showing an example in which equal comments on two video contents are distributed at double time intervals.

The comment information comparison unit 120 may use LDA-based modeling, machine learning or the like to determine similarity of comment information. The comment information comparison unit 120 may separate topics on comment data through an LDA-based clustering technique. At this point, the comment information comparison unit 120 may grasp an optimum number of categories while changing the number of categories to ten, one hundred or the like. The comment information comparison unit 120 may calculate a weighting value for each category, digitize or vectorize features of each video content using the calculated weighting value, and learn similarity through deep learning. A deep learning model may receive a comment of each video content, calculate features thereof, and recommend a similar video content. At this point, the comment information comparison unit 120 may separate morphemes from natural language comments through analysis of intent, entity, quantity and the like.

The comment information comparison unit 120 may consider different languages in determining similarity between contents of comments. For example, when contents of comments are compared, comments of a language may be translated may into another language. Accordingly, as shown in FIG. 6, although a comment of a first video content is in English and a comment of a second video content is in Chinese, the comment information comparison unit 120 may determine that the two video contents are video contents equal to each other by determining similarity between the contents.

The comment information comparison unit 120 may consider reliability of a comment in determining equality between video contents. The reliability of a comment may be determined according to the number of recommendations of users on the comment, whether the comment is automatically generated, whether the comment is an official comment or the like. For example, if the comment has been generated automatically on the basis of a video content, this may be considered as a good reflection of the content of a corresponding video, and thus if the contents automatically generated are equal or similar to each other, it may be determined that the two video contents are highly probable to be equal to each other.

The comment information comparison unit 120 may consider frequency of a comment in determining equality between video contents. For example, if a lot of the same comment is mapped to a video at a specific time, the comment may be considered as a good reflection of the content of the corresponding video, and weight of the comment can be increased in determining equality.

The comment information comparison unit 120 may consider information on a user who has inputted the comment in determining equality between video contents. The information on a user who has inputted the comment may include a sex, an age, a place of origin, a residential area, an occupation, a hobby, a political inclination and the like of the user. For example, if there are a large number of comments such as “shriek” and a small number of comments such as “yuck” at a specific time of a first video content, whereas there are a large number of comments such as “yuck” and a small number of comments such as “shriek” at the corresponding time of a second video content, it is hard to say that the two video contents are equal since reactions of users seeing the parts of the two video contents at the corresponding time are opposite. However, considering information on users inputting the comments, if comments of “shriek” are inputted by women and comments of “yuck” are inputted by men for both of the two videos, this can be a basis for saying that the two video contents are equal since responses of users according to sex are equal.

The comment information comparison unit 120 may consider information on an input situation of a comment in determining equality between video contents. The information on an input situation of a comment may include an input time, an access area, an access method, an access device, a used video service, a social media type in case of social login. For example, although users watch the same video, the responses may vary depending on a country where a user belongs to, and this may be considered through an access area when a comment is inputted. As another example, since responses of users may vary depending on a comment input time, similarity between comments can be calculated with respect to two axes of a time axis of playing back the video content to which comments are mapped, and a time axis of inputting comments, to consider the comment input time. In addition, the input time may be classified in a variety of methods, such as an epoch, a time point and a cycle, and considered to take into account not only similarity of the input time, but also responses of users that may vary according to time periods (e.g., comments inputted in the 2110s, and comments inputted in the 2120s), responses of users that may vary according to a specific time point (e.g., comments inputted before and after release of a movie, and comments inputted during and after airing of a drama), and responses of users that may vary according to a cycle (e.g., comments inputted during a Christmas season for the movie ‘Love Actually’).

The comment information comparison unit 120 may visualize and display comment information so that a user may visually confirm the comment information, and receive information on equality between the video contents from the user. That is, the comment information comparison unit 120 may visualize and display the comment information on the first video content and the comment information on the second video content according to mapping time of the comments and receive information on equality between the first video content and the second video content from the user. The comment information comparison unit 120 may accept the determination of the user (e.g., a video service manager) as is or may take the determination of the user (e.g., a video service manager) into consideration in determining equality between the video contents. Even in this case, the comment information comparison unit 120 may refer information on the user who has inputted information on equality between the video contents.

The comment information comparison unit 120 may visualize and output comment information in a variety of methods, such as a line graph, a bubble diagram, a bandwidth, a point cloud and the like, so that a user may easily determine similarity between comments. The comment information comparison unit 120 may three-dimensionally visualize and output comment information using a playback time axis as the x-axis, using reliability or the like as the y-axis, or using information on a user inputting a comment or an input situation of a comment (e.g., an input time, an access area, social media, a sex, an age) as the z-axis. The comment information comparison unit 120 may visualize and output comment information in different methods (color, shape, size, diameter of bubble, etc.) depending on criteria such as a comment type (person, place, object, product, emotion, brand, etc.), comment frequency, comment reliability, information on a user inputting a comment or an input situation, and the like.

The comment information comparison unit 120 may consider a preset error range in determining equality between video contents without a user input, and error factors may include a time, similarity of words, frequency of comments, a distance on a graph coordinate system of comments, a size of a bubble and the like.

The comment information management unit 110 may automatically construct comment information by reflecting comments on a video content in anther video when two video contents are determined as being equal. That is, when it is determined that the first video content and the second video content are equal, the comment information management unit 110 may reflect the comment information on the first video content in the comment information on the second video content and record the changed comment information on the second video content in the database. It is apparent that the comment information management unit 110 may change the comment information on the first video content in the database by reflecting the comment information on the second video content in the comment information on the first video content.

The comment information management unit 110 may reflect recommendation information on a comment, information on a user inputting a comment, and information on an input situation or the like, as well as the comment itself, in reflecting comment information. If a change (addition, modification, deletion, etc.) of the comment information occurs in a video content after information on equality between video contents is recorded in the database, the comment information management unit 110 may automatically reflect the change in the comment information of the same video contents. Therefore, the same video contents may always have equal comment information.

The comment information management unit 110 may prevent noise comments from being copied to another video content by reflecting only information on comments of high frequency or reliability among the comment information on the first video content in the comment information on the second video content when reflecting the comment information.

When the two video contents are determined as being equal and comments mapped to a video content are reflected in another video content, the content equality determination system 100 may perform again the determination of equality between the video content of the changed comment information and another video content. That is, after the second video content is determined inequal to the third video content as a result of comparing comment information of the two video contents, if the second video content is determined as being equal to the first video content and the comment information on the first video content is reflected in the comment information on the second video content, the content equality determination system 100 may determine again equality between the second video content and the third video content by comparing again the comment information of the two video contents. Accordingly, if equal video contents are determined as being inequal due to lack of comment information, the content equality determination system 100 may correctly determine again equality between the two equal video contents using comment information automatically constructed on the basis of another video content.

Specifically, the comment information management unit 110 may read the comment information on the second video content and the comment information on the third video content from the database before reflecting the comment information on the first video content in the comment information on the second video content, and the comment information comparison unit 120 may determine equality between the second video content and the third video content by comparing the comment information on the second video content and the comment information on the third video content, and if it is determined that the second video content and the third video content are inequal, the comment information on the first video content is reflected in the comment information on the second video content, and then the comment information comparison unit 120 may determine again equality between the second video content and the third video content by comparing again the comment information on the second video content and the comment information on the third video content.

Although the present invention is an invention for determining equality between video contents by comparing comment information of the video contents, it is possible to determine equality between a video content without having comment information and another video content. The content equality determination system 100 may further include a comment information creation unit (not shown) for automatically creating comment information on the basis of a video content, and when there is no comment information on the second video content, the comment information creation unit may automatically create comment information on the second video content on the basis of the second video content, record the comment information on the second video content in the database, and determine equality between the first video content and the second video content by comparing the comment information on the first video content and the comment information on the second video content. At this point, the comment information creation unit may use the invention of Korean Patent Application No. 10-2016-0112010 invented by the inventors of the present invention to automatically create comment information on the basis of a video content.

The present invention may be implemented in a computer-readable recording medium as a computer-readable code. The computer-readable recording medium includes all storage media including a magnetic storage medium, an optical reading medium and the like. In addition, data formats of the messages used in the present invention can be recorded in the recording medium.

The present invention has been described focusing on the preferred embodiments shown in the drawings. These embodiments are not intended to limit the present invention, but merely for illustrative purposes, and should be considered from an illustrative viewpoint, not a restrictive viewpoint. The true scope of the present invention should be defined by the technical spirit of the appended claims, not the above description. Although specific terms have been used herein, they have been used merely for the purpose of describing the concept of the present invention, and have not been used to limit the meanings thereof and the scope of the present invention set forth in the claims. Therefore, it will be understood by those having ordinary knowledge in the art that various modified forms and equivalent other embodiments can be made without departing from the intrinsic spirit of the present invention claimed in the claims. It should be understood that the equivalents include equivalents that will be developed in the future, i.e., all components invented to perform the same function regardless of the structure, as well as currently publicized equivalents.

1. A method of determining equality between contents, the method comprising:
reading, by a comment information management unit, comment information on a first video content from a database;
reading, by the comment information management unit, comment information on a second video content from the database; and
determining, by a comment information comparison unit, equality between the first video content and the second video content by comparing the comment information on the first video content and the comment information on the second video content.

2. The method according to claim 1, further comprising reflecting, by the comment information management unit, the comment information on the first video content in the comment information on the second video content and recording the comment information on the second video content in the database, when it is determined that the first video content and the second video content are equal to each other.

3. The method according to claim 2, further comprising:
reading, by the comment information management unit, comment information on a third video content from the database, and determining, by the comment information comparison unit, equality between the second video content and the third video content by comparing the comment information on the second video content and the comment information on the third video content, before reflecting the comment information on the first video content in the comment information on the second video content; and
determining again, by the comment information comparison unit, when it is determined that the second video content and the third video content are inequal, equality between the second video content and the third video content by comparing again the comment information on the second video content and the comment information on the third video content, after reflecting the comment information on the first video content in the comment information on the second video content.

4. The method according to claim 2, wherein the comment information management unit reflects only information on comments having high frequency or reliability among the comment information on the first video content in the comment information on the second video content and records the comment information on the second video content in the database.

5. The method according to claim 1, further comprising automatically creating and recording, by a comment information creation unit, the comment information on the second video content in the database on the basis of the second video content, when the comment information on the second video content is not in the database.

6. The method according to claim 1, wherein determining equality includes determining equality between a time section of the first video content and a time section of the second video content.

7. The method according to claim 1, wherein determining equality includes determining equality on the basis of similarity between contents of comments and similarity between mapping times of the comments.

8. The method according to claim 7, wherein determining equality includes determining similarity between contents of the comments considering different languages.

9. The method according to claim 7, wherein determining equality includes determining similarity between mapping times of the comments considering movement on a time axis.

10. The method according to claim 7, wherein determining equality includes determining similarity between mapping times of the comments considering expansion/contraction on a time axis.

11. The method according to claim 7, wherein determining equality includes determining equality on the basis of frequencies of the comments.

12. The method according to claim 7, wherein determining equality includes determining equality on the basis of reliability of the comments.

13. The method according to claim 7, wherein determining equality includes determining equality on the basis of information on users who inputted the comments.

14. The method according to claim 7, wherein determining equality includes determining equality on the basis of information on input situations of the comments.

15. The method according to claim 1, wherein determining equality includes:
visualizing and outputting the comment information on the first video content and the comment information on the second video content according to mapping times of comments; and
receiving information on the equality between the first video content and the second video content from a user.

16. The method according to claim 15, wherein visualizing and outputting the comment information includes visualizing and outputting the comment information in different methods according to at least one criterion among types of the comment, frequencies of the comments, reliability of the comments, information on users who inputted the comments, and information on input situations of the comments.

17. A system for determining equality between contents, the system comprising:
a comment information management unit for reading comment information on a first video content and comment information on a second video content from a database; and
a comment information comparison unit for determining equality between the first video content and the second video content by comparing the comment information on the first video content and the comment information on the second video content.

18. A computer-readable recording medium for storing a program which executes the method according to claim 1.
